(19) United States
(12) Patent Application Publication
(10) Pub. No.: US 2023/0256601 A1
(43) Pub. Date: Aug. 17, 2023

(54) OBJECT GRASPING

(71) Applicant: Intrinsic Innovation LLC, Mountain View, CA (US)

(72) Inventors: Li Yang Ku, Castro Valley, CA (US); Farzad Niroui, Oakland, CA (US); Nan Rong, Fremont, CA (US); Michael Stark, Mountain View, CA (US); Bhaskara Mannar Marthi, Sunnyvale, CA (US)

(21) Appl. No.: 18/111,449

(22) Filed: Feb. 17, 2023

Related U.S. Application Data
(60) Provisional application No. 63/311,386, filed on Feb. 17, 2022.

(51) Int. Cl. B25J 9/16

(52) U.S. Cl. CPC B25J 9/1666; B25J 9/163; B25J 9/1605; B25J 9/1661

(57) ABSTRACT

Methods, systems, and apparatus, including computer programs encoded on computer storage media, for generating grasps for objects within a container. One of the methods includes determining a set of grasp proposals with associated grasping windows, wherein each grasp proposal has a different respective position within a workspace. A respective set of waypoints is determined for each grasp proposal, each set comprising a pre-grasp pose and a grasp pose within the workspace. A final selected grasp proposal is used to control an end effector of a robot to grasp an object in the workspace based on a calculated grasp trajectory associated to the selected grasp proposal.

### CROSS-REFERENCE TO RELATED APPLICATIONS

This application claims the benefit under 35 U.S.C. §119(e) of the filing date of U.S. Provisional Pat. Application No. 63/311,386, filed on Feb. 17, 2022, entitled “System and Method for Object Grasping,” the entirety of which is herein incorporated by reference.

### TECHNICAL FIELD

This invention relates generally to the robotic object grasping field, and more specifically to a new and useful system and method in the object grasping field.

### BRIEF DESCRIPTION OF THE FIGURES

FIG. 1 is a flowchart representation of the method.

FIG. 2 is a schematic representation of the system.

FIG. 3 is a flowchart representation of a variant of the method.

FIG. 4 is an illustrative example of a measurement of a physical scene.

FIG. 5 is an illustrative example of determining a workspace based on the measurement.

FIG. 6 is an illustrative example of determining a set of grasp proposals across the workspace.

FIG. 7 is an illustrative example of generating waypoints for a grasp proposal.

FIG. 8 is a schematic representation of a variant of the method.

Like reference numbers and designations in the various drawings indicate like elements.

### DETAILED DESCRIPTION

This specification describes how a system can automatically generate and score grasps for grasping objects out of a container. This process allows a robot to reliably grasp objects out of a container in which they might be difficult to observe in detail and in way that avoids collisions with the container itself.

The following description of embodiments of the invention is not intended to limit the invention to these embodiments, but rather to enable any person skilled in the art to make and use this invention.

### 1. Overview

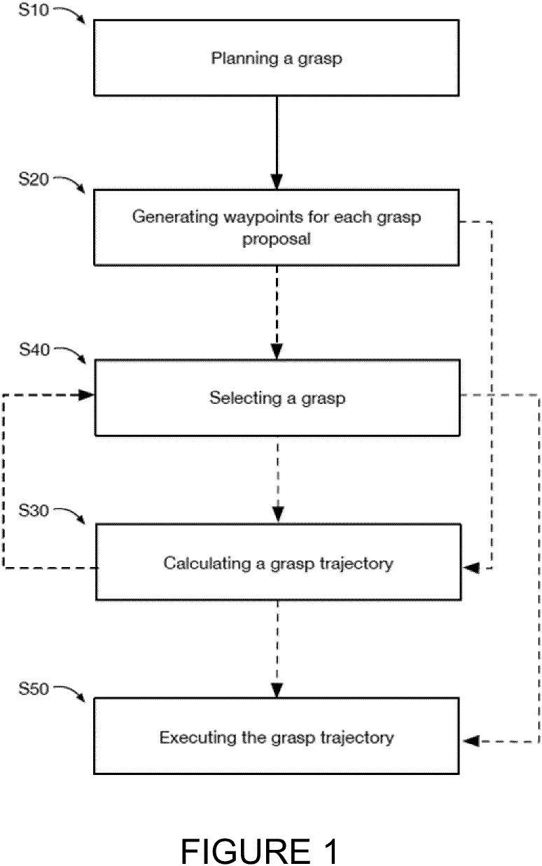

As shown in FIG. 1, the method for object simulation can include: planning a grasp S10, generating waypoints for each grasp proposal S20, calculating a grasp trajectory S30, selecting a grasp S40, and executing the grasp trajectory S50. However, the method can additionally and/or alternatively include any other suitable elements.

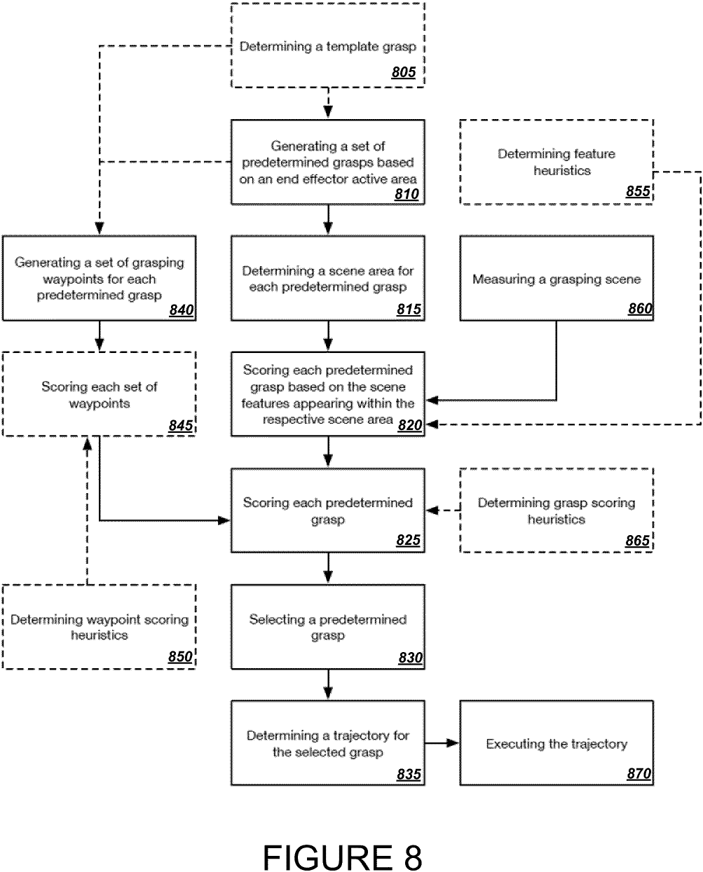

In an illustrative example, the method can include: moving a gripper in front of a box on a shelf with objects inside the box; capturing an image with point cloud information by a camera, wherein the camera is mounted in front of the gripper; based on the image, fitting planes to points determined to be lying along vertical and/or horizontal planes within the point cloud; inferring workspace boundaries (e.g., a bounding box) based on the planes and a set of heuristics to determine a virtual workspace, wherein the workspace represents all or a portion of the interior of the box; determining a set of grasp proposals (e.g., based on a template grasp, having a predetermined orientation) with associated grasping windows (e.g., representing the projection of the end effector’s active surface down to the x-y plane), wherein grasp proposals of the set have different positions within the workspace (e.g., collectively span the entirety of the workspace’s x-y dimension, have z-value defined by the scene topography under the respective window); scoring each grasp proposal based on the scene features appearing within the respective window (e.g., geometric features, visual features, etc.); optionally rotating each grasp pose by a fixed degree increment until the grasp pose does not collide with the lower lip of the box; determining a pre-grasp pose (e.g., within the workspace) and an anticipatory pose (e.g., outside the workspace) based on the grasp proposal’s position values, one or more predetermined safety margins, and a set of heuristics or rules; modeling the movement of the end effector within the physical scene from the anticipatory pose to the pre-grasp pose and from the pre-grasp pose to the grasp pose; optionally, if the grasp is simulated to collide with the workspace, adjusting the grasp pose and updating the pre-grasp pose and anticipatory pose; optionally re-scoring the grasp proposals (e.g., based on the size of the joint angle differences between the respective anticipatory pose and pre-grasp pose); selecting a grasp proposal from the set based on the grasp proposal scores; calculating a grasp trajectory for the selected grasp proposal; and controlling the robotic arm and/or end effector to grasp an object in the physical scene based on the calculated grasp trajectory associated to the selected grasp proposal (example shown in FIG. 8).

### 2. Technical Advantages

The system and method for objection simulation can confer several benefits over conventional methods.

First, variants of the technology can enable object grasping within a limited space (e.g., within a box) without having to detect individual object instances. The inventors have discovered that, in certain situations, it can be difficult to detect individual instances of objects that are deformable, featureless, have similar appearances and/or are wrapped (e.g., in reflective material, in a plastic bag), especially when multiple instances of the same object overlap (e.g., are arranged in a pile). This is particularly difficult to do when limited training data (e.g., a limited number of measurements, capturing a limited number of scenarios, etc.) is available, especially when characteristics of a target object (e.g., color, size, shape, etc.) are unknown beforehand (e.g., unknown a priori) and/or change frequently (e.g., a few times a day). In variants, this technology can overcome this challenge by predetermining a set of grasp proposals (and/or associated projection of the end effector’s active surface onto the scene; “grasp window”; etc.) based on the set of candidates. In this context, the active surface or active area of an end effector is a two-dimensional or three-dimensional space that defines how much room an end effector needs in the environment to grasp an object. Thus, for example, the active surface or active area can be defined in some implementations as the minimum rectangle or rectangular prism that completely encloses the end effector when in a position occupying the most volume or area, e.g., a fully open position of a gripper.

In variants, the grasp can be selected based on: a probability of grasp success, a grasp execution speed, and/or otherwise selected. The probability of grasp success can be determined based on the scene features appearing within each grasp window, waypoints for the grasp (e.g., calculated using safety margins, etc.), and/or otherwise determined.

Second, variants of the technology can enable faster, more accurate, and/or more efficient grasp planning and execution by: precomputing the grasp proposals (e.g., based on a grasp template, starting with a fixed grasp orientation, etc.) scene-based grasp evaluation (e.g., instead of computing grasp proposals de novo for each detect object instance); not detecting objects or object instances; analyzing the scene features for each grasp proposal in parallel; generating the waypoints independent of object detection or scene information; generating the waypoints based on a set of rules, based on the grasp proposal pose values (e.g., instead of computing the waypoints de novo); generating the trajectory after a grasp is selected; and/or by otherwise improve grasp planning and execution.

However, the system and method can confer any other suitable benefits.

### 3. System

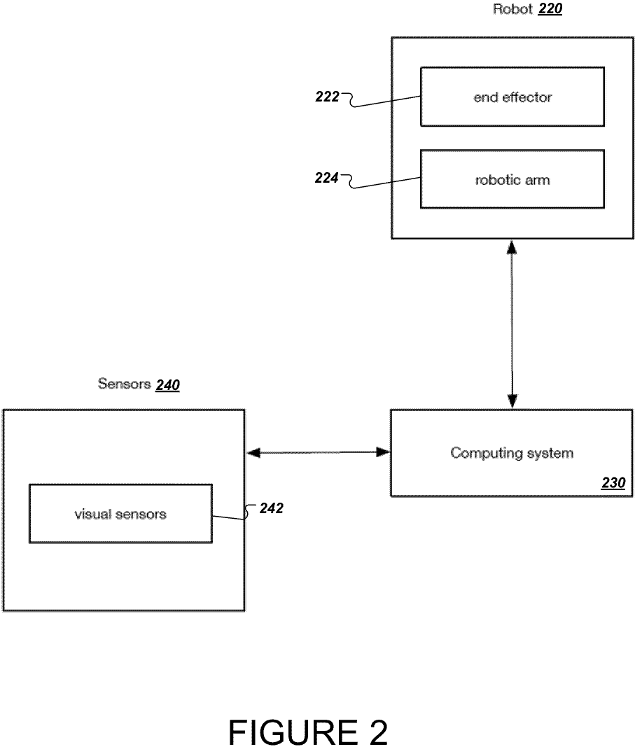

The method can be performed using a system of one or more computers in one or more locations configured to control a robot having grasping capabilities (an example of which is shown in FIG. 2) including one or more: robots 220, sensors, computing systems 230, sensors 240, and/or any other suitable components.

The robot 220 functions to manipulate an object. The robot can include one or more: end effectors 222, robotic arms 224, and/or any other suitable components. The end effector 222 can be: a suction cup, a gripper, and/or any other suitable end effector. The system can include a virtual model of the end effector 222 (e.g., virtual twin), but can alternatively not include a virtual model of the end effector 222.

The robot 220 and/or end effector 222 can be associated with an active surface (e.g., grasping region, contact region, etc.). The active surface can be associated with a projection of the end effector’s active surface (e.g., “a grasp window”) onto a plane (e.g., x-y plane, vertical plane, etc.). The grasp window (e.g., “window”) for each end effector, each grasp pose (e.g., the template grasp pose, etc.) can be known and/or predetermined for one or more end effector orientations (e.g., determined from the set of grasp proposals), but can alternatively be dynamically determined and/or otherwise determined. In a first example where a template grasp orientation is used for grasp proposal generation, the grasp window for the end effector can be determined once (e.g., based on the template grasp orientation) and reused for multiple grasps. In a second example, a different grasp window can be calculated for each grasp proposal (e.g., predetermined or determined based on scene information). However, the robot can be otherwise configured.

The sensors 240 function to sample measurements of a physical scene. The sensors 240 can include: visual sensors (e.g., monocular cameras, stereo cameras, projected light systems, TOF systems, etc.), acoustic sensors, actuation feedback systems, and/or any other suitable sensors. The sensors 240 can be: mounted to the robot (e.g., robotic arm, end effector, etc.), mounted to a superstructure (e.g., on a conveyor belt, above a picking bin/container, camera directed toward a picking bin/container, etc.), integrated into the robot (e.g., robotic arm, end effector, etc.), and/or otherwise suitably arranged. However, the sensors can be otherwise configured.

The computing system 230 functions to perform one or more steps of the method, but can additionally and/or alternatively provide any other suitable functionality. The computing system 230 can be local to the robot, remote, and/or otherwise located. However, the computing system can be otherwise configured.

The system is preferably used with a physical scene, but can alternatively not be used with a physical scene. The physical scene preferably includes one or more objects within a constrained volume, but can additionally and/or alternatively include one or more objects within an open volume. The constrained volume can be: a shelf, a box, a container, a surface, and/or any other suitable volume. The constrained volume preferably includes one or more open sides (e.g., for the robot to reach within), but can alternatively include no open sides. For example, the constrained volume can be a box (e.g., rectangular prism) with one open side and five closed sides. The open side of the box can have a lip that partially encloses the open side. However, the constrained volume can be otherwise configured. Objects can be: overlapping, non-overlapping, in a random pose, in a predetermined pose, and/or otherwise arranged. Objects can be: deformable, featureless (geometrically featureless, visually featureless, etc.), rigid, matte, have adversarial surfaces (e.g., transparent, reflective), and/or any other suitable property.

### 4. Method

As shown in FIG. 1, the method can include: planning a grasp S10, generating waypoints for each grasp proposal S20, calculating a grasp trajectory S30, selecting a grasp S40, and executing the grasp trajectory S50 and/or any other suitable elements.

The method is preferably performed by the system disclosed above, but can alternatively be otherwise performed.

All or portions of the method can be performed once, iteratively, repeatedly (e.g., for different objects, for different physical scenes, for different time frames, for different sensors), periodically, and/or otherwise performed. All or portions of the method can be performed by: a remote system (e.g., a platform), a local system, and/or any other suitable computing system.

### 4.1. Planning a Grasp S10

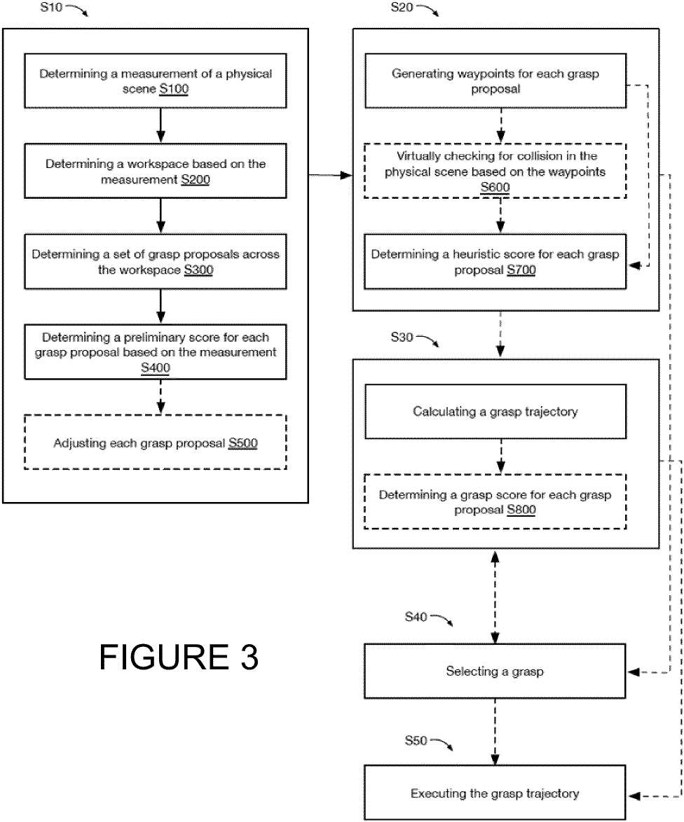

As shown in FIG. 3, S10 can include: determining a measurement of a physical scene S100, determining a workspace based on the measurement S200, determining a set of grasp proposals across the workspace S300, determining a preliminary score for each grasp proposal based on the measurement S400, optionally adjusting each grasp proposal S500, and/or any other suitable element.

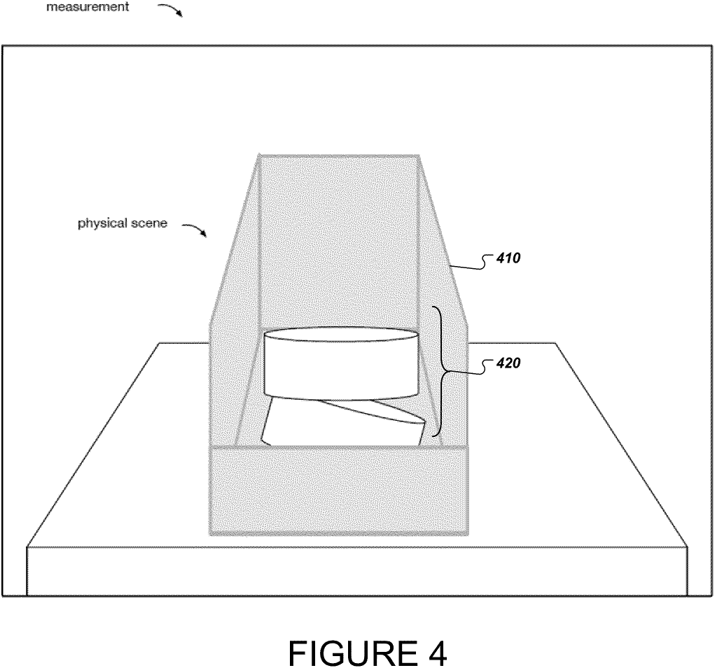

S100 functions to determine a measurement of a physical scene having a container 410 that contains one or more objects 420 to be grasped; example shown in FIG. 4. The measurement can include one measurement, multiple measurements, and/or any other suitable number of measurements. The measurement can be captured by a sensor, retrieved from a database, and/or otherwise determined. The measurement can be an image, depth information, point clouds, video, and/or any other suitable measurement. For example, S100 can include: moving a robot arm in front of a constrained volume containing objects, capturing an image (e.g., and/or depth information) with a camera, wherein the camera is mounted in front of the gripper. However, the measurement of a physical scene can be otherwise determined.

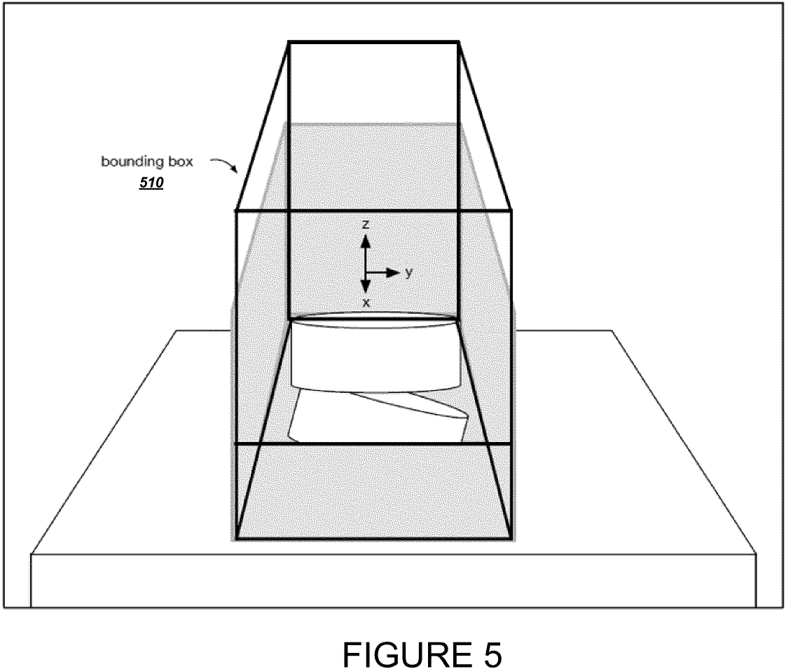

Determining a workspace based on the measurement S200 functions to define a space that the robotic arm and/or end effector can move within (e.g., the interior volume of the container, shelf, box, etc.). The workspace preferably represents all or a portion of the interior of the constrained volume defined by the container 410 (e.g., top, sides, back, all surfaces, etc.), but can alternatively not represent the interior of the constrained volume. The workspace can be a virtual workspace, but can alternatively be a physical workspace. The workspace can be represented as: a bounding box (example shown in FIG. 5), a set of planes, a virtual model, a geofence, and/or any other suitable representation. The workspace can be determined using plane fitting, heuristics, neural networks (e.g., CNNs, DNNs, etc.), rules, pattern matching, an object detector, and/or any other suitable method. For example, S200 can include: fitting planes to points determined to lie along vertical and/or horizontal planes within the point cloud, and inferring the workspace (e.g., constrained volume) boundaries based on the planes and a set of heuristics (e.g., the planes intersect at right angles). However, the workspace can be otherwise determined.

Determining a set of grasp proposals across the workspace S300 functions to determine grasp proposals within the workspace. Each grasp proposal can be associated with a virtual projection of the end effector onto the physical scene (e.g., a “window”), associated with an end effector pose (e.g., location and orientation; x, y, z position and α, β, γ orientation), and/or associated with any other suitable end effector attribute. Grasp proposals can be: predetermined, dynamically determined, randomly determined, and/or otherwise determined. All grasp proposals of the set preferably have the same orientation (e.g., the end effector is perpendicular to the x-y plane, the end effector is parallel to the x-y plane, etc.), but can alternatively have different orientations (e.g., different permutations of different α, β, γ angles; differ by 5°, 10°, etc.).

All grasp proposals of the set preferably have different positions within the workspace (e.g., vary in x and y position), but can alternatively have the same position within the workspace. The separation distance between adjacent grasp proposals can be based on a motor step distance (e.g., of the robot), based on an object size, based on the workspace size, be a predetermined distance (e.g., 5 cm, 10 cm, 100 cm, 500 cm, a range therein, etc.), and/or otherwise determined. Grasp proposals of the set can collectively span the entirety of the workspace’s x-y dimension, but can alternatively not collectively span the entirety of the workspace’s x-y dimension. The z position of each grasp proposal is preferably defined by scene topography encompassed within a window (e.g., maximum point height within a scene segment encompassed by a window, average point height within a scene segment encompassed by a window, etc.), but can alternatively be fixed, and/or otherwise determined. The window is preferably a projection of the end effector’s active surface (e.g., when the end effector is located at the grasp proposal pose) down to the x-y plane, but can alternatively be a projection of the end effector’s active surface to a vertical plane, and/or any other suitable projection.

In a first variant, S300 can include determining window dimensions (e.g., based on grasp proposals having the same orientation), determining candidate window positions in the workspace, and determining grasp proposals based on the candidate window positions. For example, the x, y, z coordinates of a window reference point (e.g., window center) is used as the grasp proposal’s x, y, z coordinates.

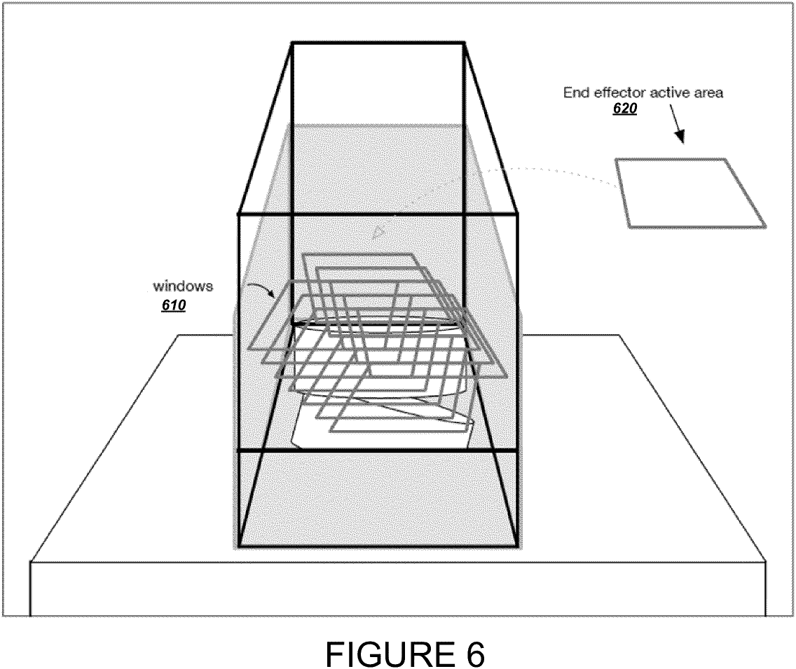

In a second variant, S300 can include determining a set of grasp proposals (e.g., by varying position and orientation; example shown in FIG. 6), determining windows for each grasp proposal (e.g., based on projection), and selecting windows and associated grasp proposals that fit within the workspace. In FIG. 6, a number of different windows 610 have been generated for a set of grasp proposals within the workspace. Each window 610 is a projection within the workspace of an end effector active area 620 of a robot. The active area can be an instance of the active surface of the end effector.

However, the set of grasp proposals can be otherwise determined.

Determining a preliminary score for each grasp proposal based on the measurement S400 functions to determine a first score representative of how favorable and/or unfavorable a grasp proposal is based on extracted features. The preliminary score can be determined based on scene features extracted from the scene segment (e.g., scene measurement segment) encompassed by the grasp proposal’s respective window and/or otherwise determined. Scene features can include: geometric features, visual features, and/or any other suitable feature type. Geometric features (e.g., extracted from 3- dimensional data, depth data, and/or point cloud) can include: corners, edges, blobs, ridges, salient points, image texture, geometric composition, Boolean composition, planes, surface normal (e.g., of a plane fitted to the depth information, average surface normal of a convex hull fit to the depth information, etc.), and/or any other suitable geometric feature. Visual features (e.g., extracted from RGB data) can include: blobs, edges, corners, gradients, ridges, and/or any other suitable visual features. Scene features can be extracted for the measurement as a whole, wherein the window is used to identify features to consider; from segments of the measurement, wherein the window is used to identify the measurement segment from which features should be extracted; and/or otherwise extracted.

The preliminary score can be a numerical score or a categorical score, a binary or non-binary score, and/or any other suitable score type. The preliminary score is preferably determined using feature heuristics, but can alternatively be determined using a model and/or any other suitable method. The preliminary score can be determined using one heuristic, a combination of heuristics, a weighted combination of heuristics, and/or any other suitable number and/or combination of heuristics. The preliminary score can be determined manually, but can alternatively be determined automatically.

In a first variant, S400 can include determining a preliminary score based on edges (e.g., of the point cloud) at the grasp proposal. For example, S400 can include assigning a more favorable score to grasp proposals with less, limited, and/or no edges (e.g., z-edges). The inventors have discovered that prioritizing grasp proposals with no edges can avoid grasping multiple objects and/or grasping edges of objects. As a result, this technology can increase efficiency and accuracy of a successful grasp.

In a second variant, S400 can include determining a preliminary score based on a surface normal at the grasp proposal. For example, S400 can include assigning a more favorable score to grasp proposals with surface normal vectors perpendicular to the x-y plane and/or parallel to a vertical vector (e.g., z-axis, gravity vector, etc.).

In a third variant, S400 can include determining a preliminary score based on a surface normal flatness at the grasp proposal. For example, S400 can include fitting a plane to the grasp proposal based on the proportion of points that fall within the plane and/or deviate from the plane, determining the variance of surface normal vectors, and assigning a more favorable score to grasp proposals with lower variance.

In a fourth variant, S400 can include determining a preliminary score based on the material of the object at the grasp proposal. For example, S400 can include determining the material of the object (e.g., using RGB imagery), and assigning a more favorable score to grasp proposals with object material more suitable for grasping (e.g., material suitable for strong suction seal), such as nonporous surfaces or flat surfaces.

In a fifth variant, S400 can include determining a preliminary score based on the position of the grasp proposal. In a first example, S400 can include assigning a more favorable score to grasp proposals closer to the front of the workspace. In a second example, S400 can include assigning a more favorable score to grasp proposals that are higher on the z-axis up to a predetermined threshold such that grasp proposals with a z- position that exceeds the threshold (e.g., close to the top of the workspace) are assigned a less favorable score. In a third example, S400 can include assigning a more favorable score to grasp proposals that are closer to the center of the workspace.

However, the preliminary score for each grasp proposal can be otherwise determined.

Optionally adjusting each grasp proposal S500 functions to adjust each grasp proposal until a predetermined condition is satisfied. The condition can be: a grasp vector does not collide with a predetermined workspace feature (e.g., lip of a box), a grasp vector is within an interval distance of a predetermined workspace feature, and/or any other suitable condition.

In a first variant, S500 can include iteratively adjusting each grasp proposal. For example, S500 can include increasing a grasp angle β and/or rotating the grasp point by a fixed degree increment (e.g., by 1°, by 5°, etc.) until the grasp point does not collide with a lower lip of a box.

In a second variant, S500 can include calculating a grasp angle (e.g., using optimization) that is needed to satisfy the condition.

In a third variant, S500 can include removing grasp proposals of the set that fail the condition from consideration for subsequent steps.

However, each grasp proposal can be otherwise adjusted.

### 4.2. Generating Waypoints for Each Grasp Proposal S20

Generating waypoints for each grasp proposal S20 functions to determine waypoints for each grasp proposal such that the robot entering the workspace through the waypoints does not collide with any objects in the physical scene (e.g., top of the shelf). S20 is preferably performed concurrently with S400 and/or after S400, but can alternatively be performed before S400 and/or any other suitable time. The waypoints can be generated based on parameters of the workspace, predetermined distances from the workspace, the grasp proposal (e.g., grasp proposal’s pose), be generated independently of scene information (e.g., only generated based on workspace information and grasp proposal information, etc.), and/or otherwise generated. The waypoints can be generated for each grasp proposal of the set, for each grasp proposal of a subset for the set of grasp proposals (e.g., grasp proposals having more than a threshold score), and/or otherwise generated.

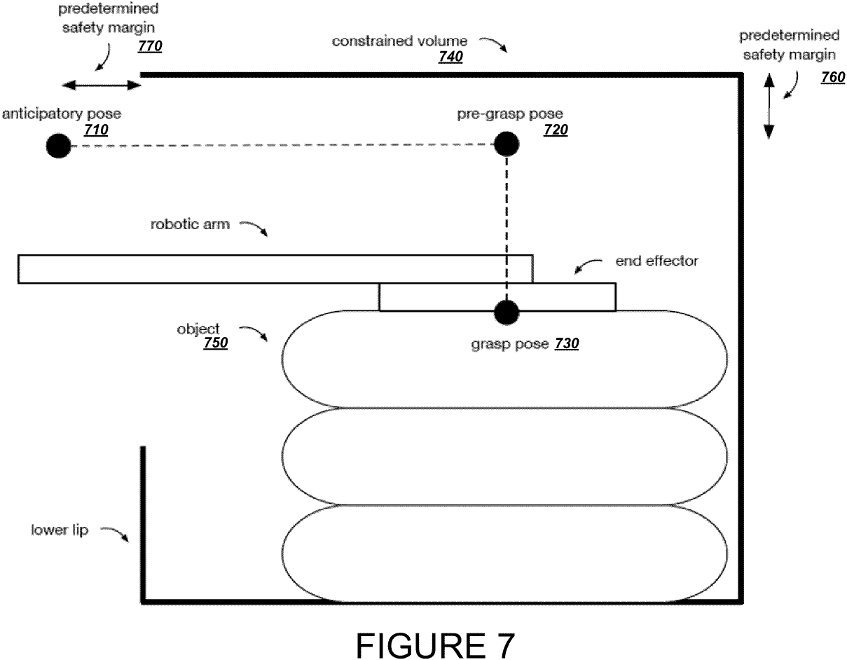

The waypoints can include two waypoints, but can alternatively include more than two waypoints, less than two waypoints, and/or any other suitable number of waypoints. The waypoints can have a pre-grasp pose (e.g., within the workspace) and an anticipatory pose (e.g., outside the workspace), but can alternatively have any other suitable pose; example shown in FIG. 7. FIG. 7 illustrates three waypoints for a grasp proposal: 1) an anticipatory pose 710 that is outside the workspace defined by the constrained volume 740, 2) a pre-grasp pose 720 that is within the workspace, and a grasp pose 730 that is used to effectuate a grasp on an object 750.

The pre-grasp pose is preferably determined by setting the x and y position of the pre-grasp pose as the x and y position of the grasp pose, and setting the z position of the pre-grasp pose as the workspace height offset by a first predetermined safety margin 760. However, the pre-grasp pose can be otherwise determined.

The anticipatory pose is preferably determined by setting the x and z position of the anticipatory pose as the x and z position of the pre-grasp pose, and setting the y position of the anticipatory pose as the workspace depth offset by a second predetermined safety margin 770, but can alternatively be determined by setting the z position of the anticipatory pose as the z position of the pre-grasp pose, setting the y position of the anticipatory pose as the workspace depth offset by a second predetermined safety margin, and setting the x position of the anticipatory pose as the most proximal workspace wall offset by or inset by a third predetermined safety margin, and/or otherwise determined.

However, the waypoints for each grasp proposal can be otherwise generated.

S20 can additionally include: optionally virtually checking for collision in the physical scene based on the waypoints S600, determining a waypoint heuristic score using one or more waypoint scoring heuristics for each grasp proposal S700, and/or any other suitable element.

Optionally virtually checking for collision in the physical scene based on the waypoints S600 functions to prevent physical collision between the robot and objects in the physical scene (e.g., top of the shelf) based on the waypoints. S600 can be performed for all grasp proposals of the set, a subset of grasp proposals of the set (e.g., over a threshold score), and/or otherwise performed. In variants, S600 can include: modeling the movement of the end effector and the physical scene from the anticipatory pose to the pre-grasp pose and from the pre-grasp pose to the grasp pose, if collision is detected, gradually adjusting the grasp pose and optionally recalculating the associated pre-grasp pose and anticipatory pose until collision is not detected, and updating the pre-grasp pose and anticipatory pose. Adjusting the grasp pose can include: changing the position of the grasp pose (e.g., lowering the grasp pose), and changing the orientation of the grasp pose (e.g., rotating the grasp pose along α, β, γ orientation).

However, collision in the physical scene can be otherwise checked.

Determining a heuristic score for each grasp proposal S700 can be based on one or more grasp scoring heuristics. This process can determine a second score representative of how favorable and/or unfavorable a grasp proposal is based on the associated waypoints, grasp parameters (e.g., orientation, location, etc.) and/or other heuristics. S700 can be performed after S500, after adjusting the grasp proposals, and/or any other suitable time. The heuristic score can be one heuristic score, multiple heuristic scores, and/or any other suitable number of heuristic scores. The heuristic score can be indicative of trajectory success, efficiency, speed, and/or any other suitable metric. The heuristic score can be a numerical score or a categorical score, a binary or non-binary score, and/or any other suitable score type. The heuristic score can be determined using heuristics, a model, a simulation, and/or any other suitable method. The heuristic score can be determined based on joint angle distances between sequential poses (e.g., waypoints), collision probability, waypoint pose relative to workspace boundaries (e.g., waypoint distance from wall), based on grasp parameters of the grasp pose, and/or otherwise determined. For example, S700 can include: for each grasp proposal, computing the distance in joint angle space between the pre-grasp pose and the anticipatory pose, and assigning a more favorable score to grasp proposals with smaller distances.

However, the heuristic score for each grasp proposal can be otherwise determined.

### 4.3. Calculating a Grasp Trajectory S30

Calculating a grasp trajectory S30 functions to estimate a grasp trajectory for the selected grasp proposal (e.g., a grasp pose) to be executed. S30 can be performed after S20, after grasp selection, before grasp selection, independent of and/or in parallel with grasp scoring, and/or any other suitable time. S30 is performed for a selected grasp proposal, all grasp proposals of the set, a subset of grasp proposals of the set (e.g., over a threshold score), and/or otherwise performed. The grasp trajectory can be calculated based on waypoints associated with the respective grasp proposal, but can alternatively be otherwise determined.

In a first variant, S30 can include: performing motion planning (e.g., from a current end effector pose to the anticipatory pose, from the anticipatory pose to the pre- grasp pose, from the pre-grasp pose to the grasp pose, from the grasp pose to the post- grasp pose (e.g., the pre-grasp pose), from the post-grasp pose to the anticipatory pose, from the anticipatory pose to an insertion pose, etc.).

In a second variant, S30 can include using methods discussed in U.S. Application No. 17/361,658 filed 29-JUN-2021, which is incorporated herein by reference.

However, the grasp trajectory can be otherwise calculated.

S30 can additionally include: optionally determining a grasp score for each grasp proposal S800, and/or any other suitable element. S800 functions to determine a third score representative of how favorable and/or unfavorable a grasp proposal is based on the preliminary and/or one or more heuristic scores. In a first example, the grasp score is the preliminary score. In a second example, the grasp score is a combination of the preliminary score and a set of heuristic scores (e.g., a weighted sum, etc.). However, the grasp score can be otherwise determined. The grasp score can be a numerical score or a categorical score, a binary or non-binary score, and/or any other suitable score type. The grasp score can be determined by leveraging neural networks, regression, classification, rules, heuristics, equations (e.g., weighted equations), instance-based methods (e.g., nearest neighbor), regularization methods (e.g., ridge regression), decision trees, Bayesian methods (e.g., Naïve Bayes, Markov, etc.), kernel methods, probability, deterministics, support vectors, and/or any other suitable method.

However, the grasp score can be otherwise determined.

### 4.4. Selecting a Grasp S40

Selecting a grasp S40 functions to determine a grasp proposal from the set based on a final score associated with each grasp proposal. The final score can be a combined score (e.g., scaled, weighted) based on the preliminary score and the one or more heuristic scores, based only on the preliminary score, based only on one heuristic score, based only on multiple heuristic scores, based only on the grasp score, and/or based on any other suitable score or combination thereof. The final score can be a numerical score or a categorical score, a binary or non-binary score, and/or any other suitable score type. The grasp proposal can be determined by selecting a grasp proposal with the highest score, selecting a grasp proposal with the lowest score, and/or otherwise determined. In a first variant, S40 can include selecting a grasp proposal based on the preliminary score. In a second variant, S40 can include selecting a grasp proposal based on one or more heuristic scores. In a third variant, S40 can include selecting a grasp proposal based on a combination of the preliminary and heuristic scores. In a fourth variant, S40 can include selecting a grasp proposal based on the grasp score or a combination with preliminary score and/or heuristic score.

However, the grasp can be otherwise selected.

### 4.5. Executing the Grasp Trajectory S50

Executing the grasp trajectory S50 functions to move the robotic arm and/or end effector to grasp an object in the physical scene based on the calculated grasp trajectory associated to the selected grasp proposal. S50 is preferably executed by the robot, but can additionally and/or alternatively be executed by the computing system and/or any other suitable component.

However, the grasp trajectory can be otherwise executed.

FIG. 8 is a flowchart of an example process for generating a grasp within a container. The example process can be performed by a system of one or more computers in one or more locations that are configured to control the operation of a robot having grasping capabilities. The process will be described as being performed by a system of one or more computers, e.g., the computer system 230 of FIG. 2.

The system generates a set of predetermined grasps based on an end effector active area (810). As described above, the active area of an end effector defines an area required to accommodate the end effector performing a grasping action. In some implementations, The system can optionally generate the predetermined grasps by first determining a template grasp (805). The template grasp can be an initial orientation of the end effector of the robot, but without a fixed location. From the template grasp, the system can generate numerous identical or substantially similar grasps as a starting point.

The system determines a scene area for each predetermined grasp (815). As described above, the active area of the end effector can be projected into the constrained volume defined by the container boundaries. In some implementations, the system generates as many scene areas as are required to sufficiently cover the interior area or volume of the workspace.

The system measures a grasping scene (860). The system can perform a number of measurements of the workspace, including the container, objects within the container, the work surface, or some combination of these, in order to extract features of the scene.

The system scores each predetermined grasp based on scene features appearing within the respective scene area (820). As described above, the system can determine feature heuristics (855) that are based on whether particular features are observed within a particular scene area for a particular grasp. As one example, the system can assign higher scores to predetermined grasps that do not include any edges. This can be useful when the grasping task is picking deformable objects, such as clothing, and it is advantageous for the end effector to approaching or avoiding collisions with walls, corners, and edges of the container. As another example, the system can assign higher scores to predetermined grasps that are higher in the z-axis so that deformable objects that are on top of the pile are picked up before objects at the bottom of the pile.

The system generates a set of grasping waypoints for each predetermined grasp (840). As described above, the grasping waypoints can include one or more of an anticipatory waypoint, a pregrasp waypoint, and a grasping waypoint. The system can optionally score each set of waypoints (845) according to one or more waypoint scoring heuristics (850). For example, the waypoint scoring heuristics can include determining whether any waypoints will cause collisions with the container or another object in the operating environment. As part of this process, the system can assign lower scores to waypoints that closer to edges of the container. The waypoint scoring heuristics can also consider a likelihood of grasping success for a particular set of waypoints.

The grasping waypoints can be based on the template grasp (805), the predetermined grasps (810) or some combination of these. For example, the system can use the template grasp in order to compute a group of waypoints that are compatible with the template grasp.

The system scores each predetermined grasp (825). For example, the system can compute a score for each predetermined grasp that considers waypoint scoring, grasp scoring, or both. As described above, the score for each predetermined grasp can be based on one or more grasp scoring heuristics (865).

The system selects a predetermined grasp (830). The system can for example rank and filter the predetermined grasps according to their scores. The system can then select a single predetermined grasp having the highest score.

The system determines a trajectory for the selected grasp (835). For example, the system can generate a robotic trajectory that causes the end effector to reach all of the waypoints generated for the selected grasp.

The system executes the trajectory (870). Executing the trajectory will thus cause the robot to pick an object out of the container. The system can repeat the process illustrated in FIG. 8 after each new object is picked out of the container. Thus, the system can dynamically recompute the waypoints required to efficiently and reliably pick objects out of the container.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

In addition to the embodiments described above, the following embodiments are also innovative:

Embodiment 1 is a method performed by one or more computers to cause a robot having an end effector to grasp an object in a container having one or more objects, the method comprising:
determining a virtual workspace representing all or a portion of an interior of the container;
determining a set of grasp proposals with associated grasping windows, wherein each grasp proposal of the set has a different respective position within the workspace;
determining, for each grasp proposal in the set of grasp proposals, a respective set of waypoints comprising a pre-grasp pose and a grasp pose within the workspace based on position values of the grasp proposal;
generating, for each grasp proposal, a respective grasp proposal score based on scene features appearing within the respective window;
selecting a grasp proposal from the set based on the grasp proposal scores;
calculating a grasp trajectory for the selected grasp proposal based on the set of waypoints for the selected grasp proposal; and
controlling the end effector to grasp an object in the workspace based on the calculated grasp trajectory associated to the selected grasp proposal.

Embodiment 2 is method of embodiment 1, wherein each grasping window represents a projection of the end effector’s active surface on an x-y plane.

Embodiment 3 is the method of any one of embodiments 1-2, wherein the set of grasp proposals spans a portion of the workspace’s x-y dimension.

Embodiment 4 is the method of embodiment 3, wherein each grasp proposal has a respective z-value defined by scene topography under the associated window.

Embodiment 5 is the method of any one of embodiments 1-4, wherein the set of waypoints are based on one or more safety margins.

Embodiment 6 is the method of any one of embodiments 1-5, wherein the set of waypoints comprises an anticipatory pose outside the workspace.

Embodiment 7 is the method of embodiment 6, further comprising:
modeling movement of the end effector within the physical scene from the anticipatory pose to the pre-grasp pose and from the pre-grasp pose to the grasp pose; optionally;
determining that the end effector is simulated to collide with the workspace; and
in response, updating the pre-grasp pose and anticipatory pose in the set of waypoints.

Embodiment 8 is the method of embodiment 7, further comprising re-scoring the grasp proposals after updating the set of waypoints.

Embodiment 9 is the method of any one of embodiments 1-8, wherein generating a grasp proposal score based on the scene features appearing within the respective window comprises assigning higher scores to grasp proposals having fewer edges within the respective window.

Embodiment 10 is the method of any one of embodiments 1-9, wherein generating a grasp proposal score based on the scene features appearing within the respective window comprises assigning higher scores to grasp proposals that are higher on the z-axis.

Embodiment 11 is the method of any one of embodiments 1-10, wherein generating a grasp proposal score based on the scene features appearing within the respective window comprises assigning higher scores to grasp proposals that are closer to a front of the container.

Embodiment 12 is the method of any one of embodiments 1-11, further comprising rotating each grasp pose by a fixed degree increment until the grasp pose does not collide with the container.

Embodiment 13 is a system comprising: one or more computers and one or more storage devices storing instructions that are operable, when executed by the one or more computers, to cause the one or more computers to perform the method of any one of embodiments 1 to 12.

Embodiment 14 is a computer storage medium encoded with a computer program, the program comprising instructions that are operable, when executed by data processing apparatus, to cause the data processing apparatus to perform the method of any one of embodiments 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers to cause a robot having an end effector to grasp an object in a container having one or more objects, the method comprising:
determining a virtual workspace representing all or a portion of an interior of the container;
determining a set of grasp proposals with associated grasping windows, wherein each grasp proposal of the set has a different respective position within the workspace;
determining, for each grasp proposal in the set of grasp proposals, a respective set of waypoints comprising a pre-grasp pose and a grasp pose within the workspace based on position values of the grasp proposal;
generating, for each grasp proposal, a respective grasp proposal score based on scene features appearing within the respective window;
selecting a grasp proposal from the set based on the grasp proposal scores;
calculating a grasp trajectory for the selected grasp proposal based on the set of waypoints for the selected grasp proposal; and
controlling the end effector to grasp an object in the workspace based on the calculated grasp trajectory associated to the selected grasp proposal.

2. The method of claim 1, wherein each grasping window represents a projection of the end effector’s active surface on an x-y plane.

3. The method of claim 1, wherein the set of grasp proposals spans a portion of the workspace’s x-y dimension.

4. The method of claim 3, wherein each grasp proposal has a respective z-value defined by scene topography under the associated window.

5. The method of claim 1, wherein the set of waypoints are based on one or more safety margins.

6. The method of claim 1, wherein the set of waypoints comprises an anticipatory pose outside the workspace.

7. The method of claim 6, further comprising:
modeling movement of the end effector within the physical scene from the anticipatory pose to the pre-grasp pose and from the pre-grasp pose to the grasp pose; optionally;
determining that the end effector is simulated to collide with the workspace; and
in response, updating the pre-grasp pose and anticipatory pose in the set of waypoints.

8. The method of claim 7, further comprising re-scoring the grasp proposals after updating the set of waypoints.

9. The method of claim 1, wherein generating a grasp proposal score based on the scene features appearing within the respective window comprises assigning higher scores to grasp proposals having fewer edges within the respective window.

10. The method of claim 1, wherein generating a grasp proposal score based on the scene features appearing within the respective window comprises assigning higher scores to grasp proposals that are higher on the z-axis.

11. The method of claim 1, wherein generating a grasp proposal score based on the scene features appearing within the respective window comprises assigning higher scores to grasp proposals that are closer to a front of the container.

12. The method of claim 1, further comprising rotating each grasp pose by a fixed degree increment until the grasp pose does not collide with the container.

13. A system comprising:
one or more computers and one or more storage devices storing instructions that are operable, when executed by the one or more computers, to cause the one or more computers to perform operations comprising:
determining a virtual workspace representing all or a portion of an interior of the container;
determining a set of grasp proposals with associated grasping windows, wherein each grasp proposal of the set has a different respective position within the workspace;
determining, for each grasp proposal in the set of grasp proposals, a respective set of waypoints comprising a pre-grasp pose and a grasp pose within the workspace based on position values of the grasp proposal;
generating, for each grasp proposal, a respective grasp proposal score based on scene features appearing within the respective window;
selecting a grasp proposal from the set based on the grasp proposal scores;
calculating a grasp trajectory for the selected grasp proposal based on the set of waypoints for the selected grasp proposal; and
controlling the end effector to grasp an object in the workspace based on the calculated grasp trajectory associated to the selected grasp proposal.

14. The system of claim 13, wherein each grasping window represents a projection of the end effector’s active surface on an x-y plane.

15. The system of claim 13, wherein the set of grasp proposals spans a portion of the workspace’s x-y dimension.

16. The system of claim 15, wherein each grasp proposal has a respective z-value defined by scene topography under the associated window.

17. The system of claim 13, wherein the set of waypoints are based on one or more safety margins.

18. The system of claim 13, wherein the set of waypoints comprises an anticipatory pose outside the workspace.

19. The v of claim 18, wherein the operations further comprise:
modeling movement of the end effector within the physical scene from the anticipatory pose to the pre-grasp pose and from the pre-grasp pose to the grasp pose; optionally;
determining that the end effector is simulated to collide with the workspace; and
in response, updating the pre-grasp pose and anticipatory pose in the set of waypoints.

20. One or more non-transitory computer storage media encoded with computer program instructions that when executed by one or more computers cause the one or more computers to perform operations comprising:
determining a virtual workspace representing all or a portion of an interior of the container;
determining a set of grasp proposals with associated grasping windows, wherein each grasp proposal of the set has a different respective position within the workspace;
determining, for each grasp proposal in the set of grasp proposals, a respective set of waypoints comprising a pre-grasp pose and a grasp pose within the workspace based on position values of the grasp proposal;
generating, for each grasp proposal, a respective grasp proposal score based on scene features appearing within the respective window;
selecting a grasp proposal from the set based on the grasp proposal scores;
calculating a grasp trajectory for the selected grasp proposal based on the set of waypoints for the selected grasp proposal; and
controlling the end effector to grasp an object in the workspace based on the calculated grasp trajectory associated to the selected grasp proposal.
